(19) United States
(12) Patent Application Publication
(10) Pub. No.: US 2017/0021388 A1
(43) Pub. Date: Jan. 26, 2017

(54) SURFACE APPEARANCE SIMULATION SYSTEM AND METHOD

(71) Applicant: Illinois Tool Works Inc., Glenview, IL (US)

(72) Inventors: Suwit John Sangkaratana, Crown Point, IN (US); Roger Fahlsing, Valparaiso, IN (US); Alan Kaufman, Crown Point, IN (US)

(73) Assignee: Illinois Tool Works Inc., Glenview, IL (US)

(21) Appl. No.: 15/288,437

(22) Filed: Oct. 7, 2016

Related U.S. Application Data
(63) Continuation-in-part of application No. 13/828,122, filed on Mar. 14, 2013.
(60) Provisional application No. 62/239,402, filed on Oct. 9, 2015.

(51) Int. Cl. B05D 1/36; B05D 7/00

(52) U.S. Cl. CPC B05D 1/36; B05D 7/58; B05D 2201/02

(57) ABSTRACT

A surface appearance simulation system includes a carrier web or fluoropolymer film, an overcoat layer disposed on the carrier web or fluoropolymer film, a pigment layer having one or more inks forming a design on the overcoat layer, and a ground coat layer. The carrier web supports the overcoat layer, the pigment layer and the ground coat layer during application of the ground coat layer with a surface of a target object prior to removing the carrier web from the overcoat layer with the carrier web directly abutting the overcoat layer without one or more slip additive materials between the carrier web and the overcoat layer prior to removing the carrier web.

### CROSS-REFERENCE TO RELATED APPLICATIONS

This application is a continuation-in-part of U.S. patent application Ser. No. 13/828,122, filed 14 Mar. 2013 (the “'122 application”). This application also claims priority to U.S. Provisional Application No. 62/239,402, filed 9 Oct. 2015 (the “'402 application”). The entire disclosures of the '122 application and the '402 application are incorporated herein by reference.

### BACKGROUND

Transfer foils can transfer a design to a substrate by applying heat and/or pressure to the foils. The substrate or foil may have a previously applied adhesive on areas where the design is to be applied to the substrate. Prior to application to the substrate, the foil can be carried on a carrier layer, which may be a more robust film or layer that supports the foil. The foil is placed against the substrate and the heat and/or pressure is applied to an opposite side of the carrier layer to transfer the design to the substrate. The carrier layer may then be removed so that the design is visible on the substrate. Additional materials such as waxes, silicone, or slip additives may be placed on the foil to enhance transfer of the foil from the carrier layer to the substrate and/or to increase the resistance of the foil design to mechanical damage (e.g., scratching).

A coating may be between the carrier layer and the foil assembly to provide some measure of protection of the design once the carrier layer is removed. For applications of the foils onto exterior architectural structures, the post-applied protective coatings may provide longer lasting protection of the foils against environmental conditions.

In order to provide for easier separation between the foils and the carrier layers, materials described above (e.g., waxes, silicon, or slip additives) can be provided between the foils and carrier layers. These materials, however, can reduce adhesion of the protective coatings to the foils. Permanent adhesion between the said coatings and the foils has proven difficult. As a result, the coatings may gradually separate from the foils and leave the foils vulnerable to damage. In order to improve adhesion between these coatings and the foils, aggressive solvents may be used. These solvents, however, typically are threatening and toxic to the environment.

A need exists for a transfer foil assembly that both provides for separation of the foils from the carrier layers, while also facilitating adhesion of protective coatings on the foils, without the use of materials that are threatening or toxic to the environment.

### BRIEF DESCRIPTION

In one embodiment, a surface appearance simulation system includes a carrier web, an overcoat layer disposed on the carrier web, a pigment layer having one or more inks forming a design on the overcoat layer, and a ground coat layer. The carrier web supports the overcoat layer, the pigment layer and the ground coat layer during application of the ground coat layer with a surface of a target object prior to removing the carrier web from the overcoat layer with the carrier web directly abutting the overcoat layer without one or more slip additive materials between the carrier web and the overcoat layer prior to removing the carrier web.

In one embodiment, a system includes a post-applied protective layer, an overcoat layer connected with the post-applied protective layer, a pigment layer having one or more inks forming a design on the overcoat layer, and a ground coat layer configured to be adhered with a surface of a target object to change an appearance of the target object using the design of the pigment layer. The overcoat layer protects the overcoat layer and the pigment layer from mechanical damage and wherein the overcoat layer and the overcoat layer are chemically bonded with each other.

In one embodiment, a method includes providing an overcoat layer onto a carrier web and depositing one or more inks to form a pigment layer on the overcoat layer. The one or more inks may form a design. The method also can include providing a ground coat layer on the pigment layer, applying an adhesive to one or more of a surface of a target object or the ground coat layer, adhering the ground coat layer with the surface of the target object using the adhesive, and removing the carrier web from the overcoat layer to cause the design in the pigment layer to appear on the surface of the target object. The carrier web is removed from the overcoat layer without one or more slip additive materials between the carrier web and the overcoat layer prior to removing the carrier web.

### BRIEF DESCRIPTION OF THE DRAWINGS

The present inventive subject matter will be better understood from reading the following description of non-limiting embodiments, with reference to the attached drawings (which are not necessarily drawn to scale), wherein below:

FIG. 1 is a perspective view of an architectural structure having a surface appearance simulation system disposed thereon according to one embodiment;

FIG. 2 is a cross-sectional view of part of the structure and the surface appearance simulation system shown in FIG. 1 according to one example;

FIG. 3 illustrates a cross-sectional view of one embodiment of a transfer foil assembly;

FIG. 4 illustrates the surface appearance simulation system connected with the structure shown in FIG. 1 according to one embodiment;

FIG. 5 illustrates the surface appearance simulation system shown in FIG. 1 affixed to the structure shown in FIG. 1 according to one embodiment;

FIG. 6 illustrates a flowchart of one embodiment of a method for forming the surface appearance simulation system;

FIG. 7 is a side view of a simulated product or structure made from a plurality of layers that may be added or applied to a substrate of the structure to form a surface appearance simulation system in accordance with an embodiment;

FIG. 8 provides one example of a grain pattern that may be provided by various sublayers;

FIG. 9 is a side view of a simulated wood product including a plurality of layers that have been applied or added to a substrate;

FIG. 10 is a schematic view of a system configured to provide a simulated product, such as the simulated wood products described above; and

FIG. 11 is a flowchart of one embodiment of a method for providing a simulated product, such as a simulated wood product.

### DETAILED DESCRIPTION

In accordance with one or more embodiments described herein, a surface appearance simulation system (also referred to as a structural member coating system), a method for providing the surface appearance simulation system, a method for coating a structural member, and coated structural members having a realistic simulated appearance are disclosed.

Embodiments provide for high quality graphics in conjunction with exterior durable materials for outdoor applications. Embodiments provide enhanced appearance and/or other attributes (e.g., durability) for structural members for exterior or outdoor applications. A structural member including a substrate having plural intermediate layers configured to provide a simulated appearance and a top coat configured to provide desirable features for exterior use may be provided. For example, a natural product (e.g., wood having a grain) may be simulated using a man-made material (e.g., plastic, composite, or the like) having performance features desirable in outdoor applications (e.g., resistance to the elements including sunlight, resistivity to abrasion, or the like). Such features may be particularly desirable in horizontal applications (such as decking or other surface across which foot traffic is expected), as well as various challenging vertical or other non-horizontal applications (such as garage doors or roofing) that may be subject to a substantial level of abuse over an expected life cycle. Structural members in accordance with various embodiments may be employed as building materials such as decking, fencing, wall panels, roofing, doors, trim, or the like. In some embodiments, Polyvinyl Chloride (PVC), Acrylonitrile Butadiene Styrene (ABS), other exterior grade plastics or composites, or the like may be employed as a substrate to which a coating is applied.

Exterior building materials may vary in appearance by one or more of substrate color, design, pattern, or decorative effects. The appearance and design of exterior building materials may be limited by product specifications, requirements, or performance needs. Performance targets, needs, or requirements may include for example, ultraviolet (UV) durability, or the ability to resist color fade, chalking, cracking, blistering, or the like due to exposure from UV radiation (e.g., from sunlight), and/or resist wear or damage from weather conditions, such as changing temperatures, precipitation, or the like. As another example, performance targets, needs, or requirements may include long term wear, including abrasion resistance from foot traffic, contact with plants, trees, or shrubs, wind abrasion from air borne dirt or debris, or the like. As yet another example, performance targets, needs, or requirements may include short term wear, or resistance to scratches or impacts. As still another example, performance targets, needs, or requirements may include chemical or stain resistance or tolerance, such as tolerance of or resistance to general cleaning chemicals, lawn care products, insecticides, general household items, or the like. As one more example, performance targets, needs, or requirements may include installation and storage characteristics. For instance, exterior building materials should be robust enough for handling by contractors, home owners, or other individuals. Various embodiments provide for desired characteristics for exterior applications, such as the characteristics discussed above.

As indicated above, structural members formed in accordance with various embodiments may be used in horizontal or vertical (or other non-horizontal orientation such as slanted) applications. Desired performance characteristics for horizontal applications may differ from desired performance characteristics for vertical (or other non-horizontal) applications. For example, a deck plank may be considered in comparison to a wall panel. The deck plank may require durability from foot traffic that a wall panel would not. Various conventional exterior building products currently available may suffer from limited design capability due to process limitation or durability requirements for a particular application. Such limitations may be particularly evident in applications where the product is oriented horizontally and may be walked upon. For example, in the decking industry, plastic or composite deck planks may be decorated in a variety of ways to attempt to simulate a wood appearance. One challenge facing these applications is to create a realistic appearance while maintaining durability characteristics to withstand foot traffic (e.g., walking, running, pet traffic, or the like), weather/environment factors (UV, moisture, wind, rain, mold, temperature change, or the like), and general considerations (e.g., pool or spa chemicals, household cleaners, yard maintenance materials such as insecticides or fertilizers, or the like).

Conventionally, materials used to simulate wood grain appearance for exterior applications may be made based on wood or wood composites originally configured for interior applications. While such materials may have relatively good graphic images and may provide wear resistance, such material (e.g., wood substrates) may not hold up to exterior conditions (e.g., effects of weather experience in exterior applications). For example, decorated surfaces configured to simulate a wood grain for interior applications may include paper in conjunction with highly cross-linked polymer coatings. Such surfaces may not move sufficiently with the normal or expected thermal expansion or contraction of a plastic or plastic composite substrate in an exterior application, which may lead to delamination of the decorative surface. Various previous attempts to simulate real wood (e.g., wood grain), for example as part of a plastic or composite substrate, have not produced results as effective as may be desired.

For example, macro embossing has been attempted to provide a textured effect to simulate cathedrals or other grains in a wood species. Macro embossing, however, does not provide a realistic wood grain simulation, instead resembling a piece of textured plastic. Further, macro embossing may be limited typically to solid colors, but may have streaks of pigment or prints in some applications.

As another example, variegation has been attempted using a color effect within an extruded part, such as via the use of different color pellets dropped into an extrusion process. However, variegation also provides a poor simulation of wood grain, instead resembling a streaked plastic part which may or may not be textured. These and other attempted techniques have achieved less than desirable results, for example, by providing poor simulation and/or failing to provide durability required for outdoor use.

Embodiments disclosed herein provide systems and/or methods for providing improved graphical simulation with durability properties configured for outdoor use. For example, a decoration may be provided using a transfer decoration (e.g., glued, thermally transferred, or the like) that provides a polymer and pigment combination that eliminates or reduces fading or degradation during an exterior product lifetime. A clear topcoat may be used in conjunction with the transfer decoration to provide one or more of wear resistance, weather resistance, or anti-slip resistance. Further, one or more of stain resistance, chemical resistance, solvent-resistance, or graffiti resistance may be provided.

For example, in embodiments, one or more layers may be employed to provide a transfer decoration that realistically simulates a desired appearance. The desired appearance may be one or more of a variety of appearances. For example, a naturally occurring appearance, such as wood, stone, ceramic, or the like may be simulated. Additionally or alternatively, a graphic image, such as a pattern (e.g., camouflage), a synthetic design, a logo, or the like may be simulated.

In some embodiments, a base or “last down” layer may be included, and be configured to facilitate bonding to a substrate or laminating adhesive. A ground coat may be included. The ground coat may provide overall background color and/or protect the substrate from UV light. Further, a graphic image may be provided. In embodiments, the graphic image may include two or more corresponding printed images that are laid down to provide a desired graphic appearance. In some embodiments, the ground coat and the graphic image may utilize inorganic oxide, complex inorganic colored pigment (CICP), exterior durable organic pigment, or the like. In various embodiments, a topcoat bonding coat may be provided, with the topcoat bonding coat configured to facilitate the bonding of the topcoat to the transfer decoration. The various layers (or materials used in the various layers) may cooperate together to provide high-quality materials that are configured to be durable for outdoor applications while still providing aesthetically pleasing graphics. Optionally, the ground coat layer may not be included. For example, if the target object to which the layers are applied has a desired color that is to be visible through the layers, the ground coat may not be included.

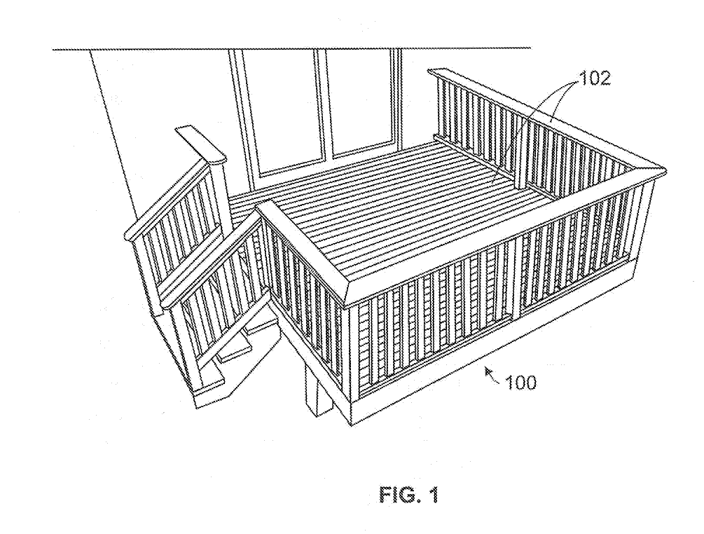

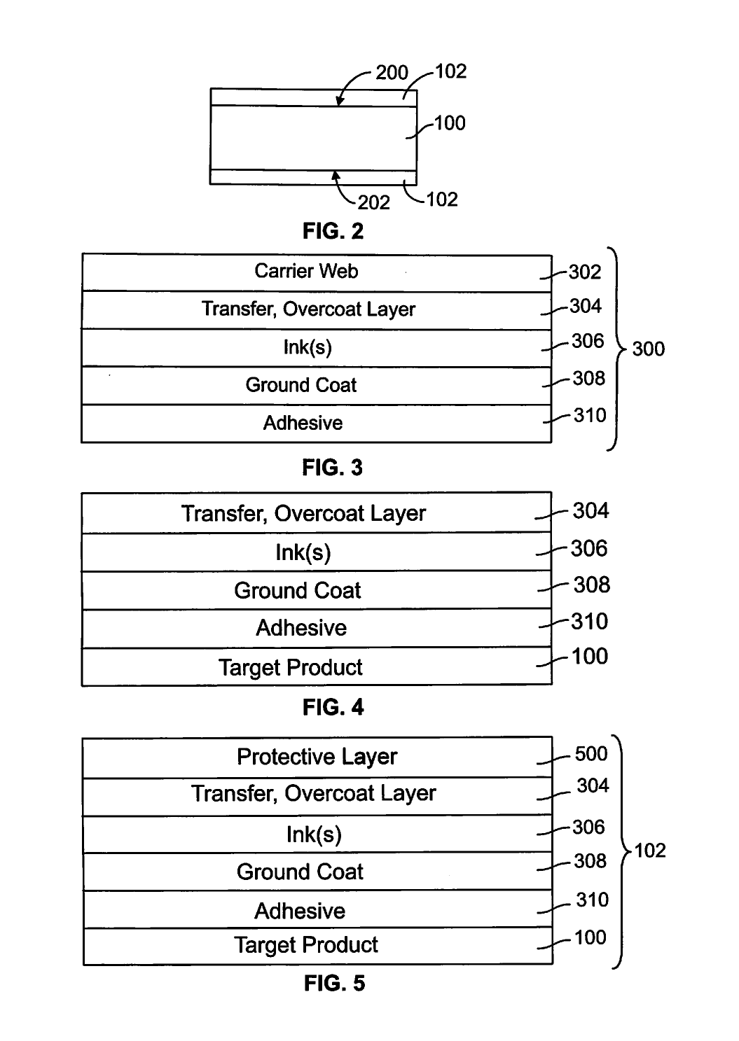

FIG. 1 is a perspective view of an architectural structure 100 having a surface appearance simulation system 102 disposed thereon according to one embodiment. FIG. 2 is a cross-sectional view of part of the structure 100 and the surface appearance simulation system 102 shown in FIG. 1 according to one example. The structure 100 is illustrated as a deck commonly connected with a home, but alternatively may represent another structure, such as a fence, post, rail, siding, wall, floor, etc. Alternatively, the surface appearance simulation system 102 may be connected with another object. The structure or object to which the surface appearance simulation system 102 is connected may be referred to as a substrate or target object herein. The illustration of a deck as the structure 100 to which the surface appearance simulation system 102 is connected is used merely as one example that does not limit all embodiments of the inventive subject matter described herein. The surface appearance simulation system 102 optionally may be referred to as a foil assembly.

The surface appearance simulation system 102 may be connected with exterior surfaces 200, 202 (shown in FIG. 2) of the structure 100 to provide a design, or appearance, to the structure 100. For example, the surface appearance simulation system 102 may provide the appearance of a wood grain to the structure 100 that is not made from wood or that does not have the wood grain appearance provided by the surface appearance simulation system 102. Alternatively, the surface appearance simulation system 102 may provide another appearance to the structure 100 or target object to which the surface appearance simulation system 102 is connected. This allows for the surface appearance simulation system 102 to provide a simulated appearance to a viewer of the structure 100. The simulated appearance makes the surface of the structure 100 appear to be made from a material or materials that the structure 100 does not include or that differs from the exterior surface of the structure 100 without the surface appearance simulation system 102.

FIG. 3 illustrates a cross-sectional view of one embodiment of a transfer foil assembly 300. The transfer foil assembly 300 may be applied to the exterior surface of a target object (e.g., the structure 100 shown in FIG. 1) to transfer the surface appearance simulation system 102 to the target object. The transfer foil assembly 300 includes a carrier web 302 that mechanically supports additional layers, films, etc. (referred to herein as components) shown and described herein. The carrier web 302 may support these components during movement of the transfer foil assembly 300 to the target object and during transfer of the surface appearance simulation system 102 (or at least part of the surface appearance simulation system 102) to the target object. As described below, the carrier web 302 is removed after transfer of the surface appearance simulation system 102 onto the target object.

The carrier web 302 may be formed from a variety of materials having sufficient strength to support the additional components of the surface appearance simulation system 102. In one embodiment, the carrier web 302 is formed from a polymer such as a polyester film. For example, the carrier web 302 can be formed from biaxially-oriented polyethylene terephthalate (BoPET). In another embodiment, the carrier web 302 is formed from a polyamide material, such as nylon. Optionally, the carrier web 302 may be formed from another material.

An overcoat layer 304 is disposed on the carrier web 302. The overcoat layer 304 may be a transfer, overcoat layer and may be formed from materials that allow the transfer, overcoat layer 304 to mechanically separate from the carrier web 302 without the additional materials used in other known transfer foil assemblies. For example, the transfer, overcoat layer 304 may be formed from materials that allow the transfer, overcoat layer 304 to separate from the carrier web 302 without requiring or including waxes, silicone, slip additives, or other materials to the interface between the transfer, overcoat layer 304 and the carrier web 302. The absence of these additional materials may mean that the transfer, overcoat layer 304 directly abuts the carrier web 302 without any other materials disposed between the transfer, overcoat layer 304 and the carrier web 302. Alternatively, the overcoat layer 304 may not be separated from the carrier web 302.

The transfer, overcoat layer 304 may be formed from a new and inventive blend of polymers, monomers, oligomers, and/or pre-polymers. The polymers may be formed from monomers based on acrylate or methacrylates, vinyl chloride, and/or vinyl acetate and cellulosic monomers. The monomers may include, but are not limited to, the methyl, ethyl, butyl, and/or ethylhexyl families (or combinations thereof). In one embodiment, the polymers used to form the transfer, overcoat layer 304 can be modified with functional groups, such as hydroxyl, carboxyl, amine, glycidyl, etc. These functional groups can add functionality to the polymer or polymers forming the transfer, overcoat layer 304 with a range of molecular weights (Mw) between 30,000 to 120,000 (or between 30,000 and 500,000), having a glass transition temperature (Tg) range of 35 to 140 degree centigrade, and/or acid numbers of 2.5 to 200. The acid number may represent the mass of potassium hydroxide (in milligrams) that is required to neutralize one gram of a chemical substance. Alternatively, other functional groups can be added and/or the functionality of the transfer, overcoat layer 304 may be different from one or more of the values described above. Manufacturers of such resins include Lucite International, Dow Chemicals, Mitsubishi and others, and one example of a family of resins that can be used in one embodiment of the transfer, overcoat layer 304 includes the Elvacite Acrylic Resins manufactured by Lucite International.

Optionally, one or more other materials may be incorporated into the transfer, overcoat layer 304. One or more monomers, oligomers, pre-polymers, and/or reactive polymers that include materials manufactured by Sartomer, Dymax, Allnex or others can be incorporated into the transfer, overcoat layer 304. The layer 304 may be partially cured to cause these materials to cross link to specific reactive sites in the transfer, overcoat layer 304, such as isocyanate, melamine, or another radiation curable component in the layer 304.

One or more inks form a pigment film 306 (“Ink(s)” in FIG. 3) that is connected with the transfer, overcoat layer 304. The pigment film 306 is adhered to the transfer, overcoat layer 304 to prevent separation between the pigment film 306 and the transfer, overcoat layer 304. The pigment film 306 may yield the design or appearance of the surface appearance simulation system 102, such as a wood grain or other images or appearances via printing methods known in the industry. The pigment film 306 may be formed by one or more pigments deposited onto the transfer, overcoat layer 304. The pigmentation used to create the design represented by the pigment film 306 may include pigments that are resistant to fading and color change during long term exterior exposure. The pigments used may be chosen from performance organic pigments, inorganic oxides, or complex inorganic colored pigments (CICP). In one embodiment, the pigments are CICPs. In one aspect, the pigments include a subset of CICPs that are reflective to heat. This can allow for the foil assembly 102 to hold color and reduce or minimize heat absorption from sunlight.

A ground coat layer 308 is disposed on a side of the pigment film 306 that is opposite of the transfer, overcoat layer 304. The ground coat layer 308 may be formed from one or more of the same materials as the transfer, overcoat layer 304. In one embodiment, the ground coat layer 308 is formed from the same material as the transfer, overcoat layer 304. An adhesive 310 is applied to the ground coat layer 308. The adhesive 310 couples or otherwise affixes the transfer, overcoat layer 304, the pigment film 306, and the ground coat 308 to the structure 100. Optionally, the adhesive 310 may be applied to the structure 100 and then connected with the ground coat layer 308 when the ground coat layer 308 is placed into contact with the adhesive 310. The materials used in the adhesive 310 can be selected from those that yield excellent adhesion to both the ground coat layer 308 and the target object (e.g., the substrate) 100. This generally means that these materials have mutual compatibility, miscibility, surface wetting, and including, but not limited to, similarity in chemical and physical properties. Examples of materials that have been used successfully and well known to those familiar with the arts are PMMA and its copolymers, PVC, Cellulose esters, EVA (ethylene vinyl acetate), CPO (chlorinated polyolefin) to name a few. Alternatively, the ground coat layer 308 may not be included.

In one embodiment, the inks forming the pigment film 306 are directly printed onto the overcoat layer 304. For example, one or more ink jet or other printers may deposit the ink or inks forming the pigment film 306 onto the overcoat layer 304 without the ink or inks being previously printed or otherwise deposited on any other component, such as the ground coat layer 308. An observer of the pigment film 306 can determine that the inks forming the pigment film 306 are directly printed on the overcoat layer 304 when no other layer is present or located between the inks and the overcoat layer 304. Alternatively, the inks forming the pigment film 306 may not be directly printed onto the overcoat layer 304, but may be first printed onto another layer that is coupled with the overcoat layer 304. For example, one or more ink jet or other printers may deposit the ink or inks forming the pigment film 306 onto the ground coat layer 308, which is then coupled with the overcoat layer 304 after the printing is completed.

FIG. 4 illustrates the overcoat layer 304, the pigment film 306, and the ground coat layer 308 connected with the structure 100 (“Target Product” in FIG. 4) by the adhesive 310 according to one embodiment. In order to apply the surface appearance simulation system 102 to the structure 100, the adhesive 310 is placed into contact with the exterior surface 200, 202 of the structure 100. Pressure and/or heat is applied to the carrier web 302 to cause the adhesive 310 to bind with (or otherwise affix to) the exterior surface 200, 202 of the structure 100. The carrier web 302 is then pulled away in order to separate the carrier web 302 from the transfer, overcoat layer 302, the pigment layer 306, and the ground coat layer 308. The transfer, overcoat layer 304, the pigment film 306, and the ground coat layer 308 may form part of the surface appearance simulation system 102 shown and described above.

FIG. 5 illustrates the surface appearance simulation system 102 affixed to the structure 100 (“Target Product” in FIG. 5) according to one embodiment. After the transfer, overcoat layer 304, the pigment film 306, and the ground coat layer 308 are adhered to the structure 100 by the adhesive 310, a post-applied protective layer or overlay laminated layer 500 can be applied onto the transfer, overcoat layer 304 to form the surface appearance simulation system 102. The protective layer 500 may be formed from one or more fluoropolymers. Optionally, the post-applied protective layer or overlay laminated layer 500 may not be included in the surface appearance simulation system 102.

The post-applied protective layer or overlay laminated layer 500 can be formed from one or more of the same materials as the transfer, overcoat layer 304. In one embodiment, the component 500 is an overcoat layer 500 that is applied as a liquid onto the transfer, overcoat layer 304. Alternatively, the component 500 is an overlay layer 500 that is laminated onto the transfer, overcoat layer 304. Such an overlay layer 500 may be formed by extruding or co-extruding materials suitable for outdoor use such as acrylic, polyurethane, Surlyn, Tedlar and others. One example is poly vinyl difluoride polymer and/or an alloy of the poly vinyl difluoride polymer, and optionally with a UV light absorbing and stabilizer material package. The layer or layer 500 protects the underlying components of the surface appearance simulation system 102 from damage, such as by protecting the components against harsh outdoor environments typically encountered by structures 100 such as decks, fences, posts, rails, sidings, etc. Adhesion between the layer or film 500 and the transfer, overcoat layer 304 may occur via physical and chemical bonding between reactive sites in the layer/film 500 and the layer 304. This adhesion may be an improvement over known surface appearance simulation systems in that strong adhesion is generated without the use of aggressive solvents or other materials that are toxic or threatening to the environment.

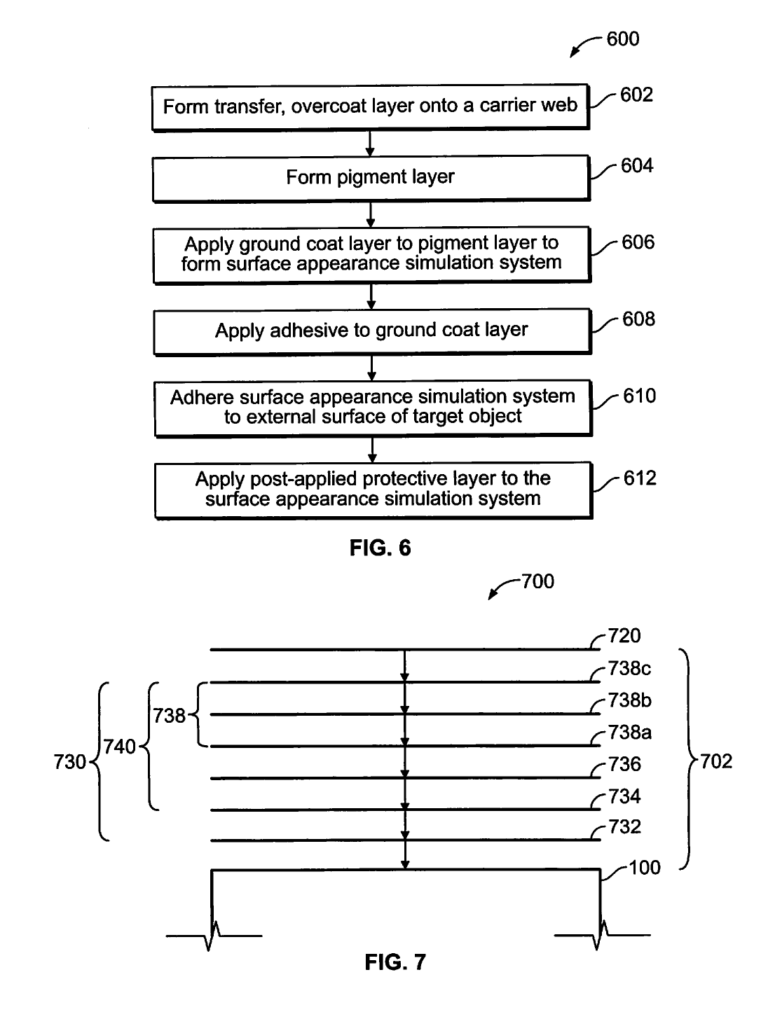

FIG. 6 illustrates a flowchart of one embodiment of a method 600 for forming a surface appearance simulation system. The method 600 may be used to change the outward appearance of surfaces of a target object so that these surfaces appear differently. For example, the method 600 may fabricate and/or apply the surface appearance simulation system to a structure formed from a material other than wood to make the exterior surfaces of the structure appear to be surfaces of wood. As another example, the method 600 may fabricate and/or apply the surface appearance simulation system to a structure formed from a material other than stone to make the exterior surfaces of the structure appear to be surfaces of stone. As another example, the method 600 may fabricate and/or apply the surface appearance simulation system to a structure formed from a material other than metal or metal alloys to make the exterior surfaces of the structure appear to be metallic surfaces.

At 602, an overcoat layer is formed onto a carrier web. The overcoat layer 304 may be formed by depositing the material(s) forming the overcoat layer 304 on the carrier web 302. At 604, a pigment layer is formed. The pigment layer is the layer that provides the simulated appearance provided by the surface appearance simulation system. For example, the pigment layer may be formed by printing one or more pigments or inks onto the transfer, overcoat layer 304. The pigments or inks may be deposited in an arrangement that simulates (e.g., looks like) another material, such as a wood grain. The pigment layer 306 may be formed using ink jet printing directly onto the overcoat layer 304. Optionally, another printing technique may be used, such as gravure, flexo, or screen printing to form the pigment layer 306.

At 606, a ground coat layer is applied to the pigment layer. The ground coat layer 308 may be placed on the pigment layer 306, or the materials forming the ground coat layer 308 may be deposited onto the pigment layer 306 to form the surface appearance simulation system described herein. At 608, an adhesive is applied to the ground coat layer of the surface appearance simulation system on a side of the ground coat layer that is opposite the pigment layer. The adhesive 310 may be applied to the ground coat layer 308, the external surface 200, 202 of the structure 100, or to both the ground coat layer 308 and the external surface 200, 202 of the structure 100.

Alternatively, the pigment layer may be formed on the ground coat layer, and then the pigment layer is adhered to the overcoat layer to form the surface appearance simulation system. For example, the pigment layer can be created by printing inks onto the ground coat layer, which is then applied to the overcoat layer.

At 610, the surface appearance simulation system is adhered to the external surface of a target object by the adhesive. For example, pressure and/or heat may be applied to the carrier web 302 of the surface appearance simulation system, which causes the adhesive 310 to affix the ground coat layer 308 with the structure 310. The pressure and/or heat also cause the carrier web 302 to separate from the transfer, overcoat layer 304. Due to the materials used to form the transfer, overcoat layer 304, there may not be any waxes, silicone, slip additives, or the like, in a release carrier layer between the carrier web 302 and the transfer, overcoat layer 304 to assist in separating the carrier web 302 from the transfer, overcoat layer 304.

At 612, a post-applied protective layer is applied to the surface appearance simulation system. In one embodiment, the post-applied protective layer 500 is applied to the transfer, overcoat layer 304 by depositing the layer 500 onto the overcoat layer 304 as a liquid and allowing the layer 500 to cure. Adhesion of the post-applied protective layer 500 to the transfer, overcoat layer 304 may be provided by physical and chemical bonding between the layers 304, 500. Alternatively, the component 500 may be a film 500 that is laminated onto the transfer, overcoat layer 304, such as by using extrusion or co-extrusion to form the film 500. The absence of waxes, silicone, slip additives, or the like, in a release carrier layer between the carrier web 302 and the transfer, overcoat layer 304 prevents these materials from being present on the transfer, overcoat layer 304. Because these materials can impede the formation of physical and chemical bonds between the layers 304, 500, the strength of adhesion of the layer or film 500 to the layer 304 is improved.

FIG. 7 is a side view of a simulated product or structure 100 made from a plurality of layers that may be added or applied to a substrate of the structure 100 to form a surface appearance simulation system 702 in accordance with an embodiment. It should be noted that FIG. 7 is a schematic, conceptual depiction and is not intended to be to scale. Different layers of the surface appearance simulation system 702 may have varying thicknesses in various embodiments. In some embodiments, more layers of a given type, less layers of a given type, more types of layers, and/or less types of layers may be employed. For example, a given layer depicted in FIG. 7 may not be present in various embodiments, and/or a layer not depicted in FIG. 7 may be present in various embodiments. Further, the illustrated embodiment is discussed in the context of simulated wood grain, but other simulation may be achieved in other embodiments. For example, other natural materials such as stone, ceramic, tile, or the like may be simulated. Further, graphic images such as patterns, designs, logos, or the like may be provided in embodiments.

The surface appearance simulation system 702 on the structure 100 depicted in FIG. 7 includes an intermediate portion 730 including a plurality of intermediate layers 732, 734, 736, 738 disposed between the structure 100 (e.g., an exterior surface of the structure 100) and a top coat 720. The structure 100 and/or one or more of the layers of the intermediate portion 730 and/or the top coat 720 may be comprised of durable exterior components. For example, the top coat 720 may have a durable formulation including inorganic particles. In some embodiments, the top coat 720 may be a relatively thin coating with a relatively lightly textured surface for slip and durability enhancement. The top coat 720 may be or may include the overcoat layer 304 and/or the protective coating 500 described above. The intermediate portion 730 may provide a realistic simulation of a cathedral or other wood grain pattern that appears close to the surface (e.g., covered only by the relatively thin top coat 720) and/or having a layered or three-dimensional appearance. Cathedral grain may be understood as a specific grain pattern characterized by a series of stacked “V” and/or inverted “V” shapes. This pattern is common to flat cut or plain sliced veneer. Other grain patterns may be simulated additionally or alternatively in various embodiments. In FIG. 7, the various layers are depicted only on top of the structure 100, but layers could be applied to the sides and/or bottom of the structure 100 as well in various embodiments (see, e.g., FIG. 2).

Returning to FIG. 7, the structure 100 may be a structural member such as a plank, board, beam, sheet, or the like. In the illustrated embodiment, the structure 100 is a plank sized and configured to be used for decking, and a number of such planks may be used to provide the surface of a deck upon which people may walk, stand, sit, or the like. The structure 100 may be provided in one or more predetermined lengths. In some embodiments, the structure 100 may be plastic or composite. Generally speaking, the structure 100 is configured to provide the structural strength, rigidity, and/or other properties that may be required or desired for a simulated wood product. The various layers and top coat 720 are provided over one or more surfaces of the structure 100 to provide a realistic wood grain appearance to the simulated wood product.

In the illustrated embodiment, the intermediate portion 730 is configured to provide a realistic simulation of a wood material, for example a wood grain. The intermediate portion 730 includes a plurality of layers (e.g., a visual effect simulation portion 740) that cooperate to provide a wood-like appearance. The intermediate portion 730 may be one or more of the pigment layers 306 described above. By “cooperate,” it is meant that a visual design or appearance on each of the plurality of layers is based on the visual design or appearance on one or more, or all, of the other layers in the plurality of layers. For example, the spatial location of the design, the arrangement of two or more designs, the spacing between designs, and the like, on a first layer may be created in order to be oriented in a designated or preselected relationship with the design or appearance of one or more other designs on a second layer (and/or on multiple other layers). The designs on the plurality of layers can be arranged relative to each other such that, when the layers are stacked on top of one another, a composite design is created. The composite design may be a mixture or other combination of the different designs on the different layers, and may be different from the designs of one or more, or all, of the layers in the plurality of layers. In an embodiment, the designs on the layers do not physically or chemically mix with each other, but remain separate to provide the composite design.

The intermediate portion also includes an adhesive layer 732 configured to help secure the intermediate portion 730 to the structure 100. The adhesive layer 732 may be or may include the adhesive layer 310 described above. The intermediate portion 730 thus may be seen as an including an adhesive layer 732 as well as the visual effect simulation portion 740. The use of layers, for example, as depicted in FIG. 7, may provide realistic simulation of wood grain, allowing for the appearance of visual depth to provide a realistic simulation of wood grain. It should be noted that a given layer depicted as an individual layer in FIG. 7 may be achieved or replaced by multiple layers or sublayers. In various embodiments, various layers may be applied sequentially to a substrate (e.g., one or more lower layers applied first, one or more intermediate layers then applied after the one or more lower layers, and one or more upper layers then applied after the one or more intermediate layers). In other embodiments, the intermediate portion 730 may be applied at a single time, with the various layers arranged, for example, as a foil that is applied to the structure 100. In still other embodiments, for example, the adhesive layer 732 may first be applied, with the visual effect simulation portion 740 subsequently applied as a foil. In various embodiments one or more foils (with each foil comprising a plurality of layers may be applied. For example, all or some of the layers of the visual effect simulation portion 740 may be provided as a foil. As another example, the entire intermediate portion 730 may be provided as a foil.

The adhesive layer 732 is the portion of layer of the intermediate portion 730 in the illustrated embodiment that is positioned most closely to a surface of the structure 100. The adhesive layer is configured to adhere, bond, secure, or the like the various other layers to the structure 100. The adhesive layer 732 may be a liquid, for example. A liquid adhesive layer may be applied to the structure 100, for example, by a coating or spraying operation. In some embodiments, the adhesive layer 732 may be heat activated and thermally applied. In some embodiments, the adhesive layer 732 may be applied before any other layers of the intermediate portion 730, while in other embodiments, the adhesive layer 732 may be applied at the same time as one or more additional layers, for example as a foil comprising multiple layers that is applied to the structure 100, with the adhesive layer 732 of the foil oriented most closely toward the surface of the structure 100 to which the foil is to be applied. The adhesive layer 732 may be configured to act as a primer layer for the visual effect simulation portion 740 or a layer thereof. In some embodiments, a primer layer may be positioned or applied above the adhesive layer 732.

The visual effect simulation portion 740 includes layers that are configured to cooperate with each other to provide a simulation of wood grain. One or more layers may have patterns that are configured to coordinate or otherwise correspond with patterns of one or more other layers, for example, with various portions of a grain pattern provided by different layers. In some embodiments, a leading edge of a grain may be provided by a first layer, an intermediate portion of the grain provided by a second layer, and a trailing edge of a grain provided by a third layer. Alternatively or additionally, varying shadings between portions of a grain pattern may be provided by a plurality of layers.

One or more of the layers may be substantially solid in shade or color, for example, to provide a base color to the wood simulation. One or more layers that include a pattern may be applied above the substantially solidly colored layers. Layers that include a pattern may be partially or fully transparent or translucent allowing patterns from layers disposed beneath to show through the given layer, so that the layers can provide visual depth or have a three-dimensional appearance. For example, an undertone or base color may be provided with varying patterns of grain imposed on top. Such a layered grain simulation may provide a more realistic simulation of wood grain than approaches using lines, streaking, or the like drawn or otherwise formed in an attempt to provide a profile or outline of wood grain. The visual effect simulation portion 740 may be formed as a foil and applied together (with or without the adhesive layer 732). The visual effect simulation portion 740 may include one or more foils and be applied in one or more steps. The visual effect simulation portion 740 may be applied at the same time as the adhesive layer 732 in some embodiments, and may be applied subsequent to the adhesive layer 732 in other embodiments. The visual effect simulation portion 740 in the illustrated embodiment includes a ground coat layer 734, a print undertone layer 736, and a print layer 738.

The ground coat layer 734 in the illustrated embodiment is configured for exterior use and configured for durability. The ground coat layer 734 may be or may include the ground coat layer 308 described above. The ground coat layer 734 in the illustrated embodiment is positioned or applied above the adhesive layer 732 (e.g., with the adhesive layer 732 interposed between the structure 100 and the ground coat layer 734.) In some embodiments, a primer layer (not shown in FIG. 7) may be interposed between the adhesive layer 732 and the ground coat layer 734. The ground coat layer 734 of the illustrated embodiment provides a base for additional layers of the visual effect simulation portion. The ground coat layer 734 may be the same color or a different color than the print undertone layer 736.

The print undertone layer 736 in the illustrated embodiment is positioned above the ground coat layer 734 (e.g., with the ground coat layer 734 interposed between the print undertone layer 736 and the structure 100). In the depicted embodiment, the print undertone layer 736 is configured for exterior use and configured for durability. In various embodiments, the print undertone layer 736 may be the same color or shade as the ground coat layer 734, or may be a different color or shade than the ground coat layer 734 (e.g., the print undertone layer 736 may be a lighter shade or color than the ground coat layer 734). In some embodiments, the print undertone layer may be translucent or have variable translucence to allow a portion of the ground coat layer 734 to appear through the print undertone layer. In other embodiments, the print undertone layer may be substantially opaque and not allow substantial visual appearance of any portion of the ground coat layer 734. Generally, in various embodiments, the print undertone layer 736 may be selected or configured to simulate a base color of a given type or variety of wood (e.g., maple, pine, cedar, redwood, or the like). In some embodiments, the print undertone layer 736 may be lighter in color than portions of the print layer 738 (or sub-layers forming the print layer 738) to allow the appearance of darker grain patterns over a lighter base color. In some embodiments, the print undertone layer 736 may be substantially uniform in color or shade distribution, while in other embodiments, the print undertone layer 736 may have variance or gradation of shade.

The print layer 738 may include a plurality of sublayers (e.g., from 3-10 sublayers) configured to provide a realistic layered depth effect. The print layer 738 in the illustrated embodiment is configured to be durable for exterior use, and configured to provide a high fidelity print simulation. For example, the print layer 738 may be configured to provide a realistic wood grain appearance over the print undertone layer 736. One or more layers of the print layer 738 in the illustrated embodiment are partially translucent or transparent to allow at least a portion of a layer or sublayer there beneath to be perceived by viewer. For example, a portion of a sublayer configured to simulate a grain pattern or portion of a grain pattern may be substantially opaque while other portions of the sublayer may be translucent or transparent. The print layer 738 may be formed of one or more pre-printed sheets or foils that are configured to have corresponding fiducial points that correspond with points of other layers, with the various layers cooperating to provide a simulated appearance. For example, each of a plurality of layers or sublayers may contribute a discrete portion of an overall pattern (such as a wood grain), with the contributions of the various layers or sublayers aligned to provide a unified effect when the layers are applied together. Thus, various portions of a grain pattern may be lighter or darker and/or have the appearance of varying depth relative to other portions of a grain pattern provided on other layers or sublayers.

For example, some portions of a grain pattern may be lighter (and/or be underneath one or more translucent layers) while other portions may darker (and/or above other layers). For example, one layer may be used to provide an interior portion of a grain (e.g. quilt, flame, burr, knot, or the like) and may be relatively dark, and a corresponding edge of the grain (e.g., an outer portion of a knot, a ring, or the like) may be lighter. As another example, one edge of a grain pattern may be darker and one edge lighter. Further, multiple layers may cooperate to provide additional shadings between portions of a grain pattern and/or additional depth layers of a grain pattern. Thus, multiple layers or sublayers may be employed to provide variations in shade and/or depth to provide a realistic simulation of wood grain.

In the illustrated embodiment, the print layer 738 includes sublayers 738a, 738b, 738c. Three sublayers are shown in the illustrated embodiment; however, more or less sublayers may be employed in other embodiments. Each sublayer can be or include a pigment layer 306 described above.

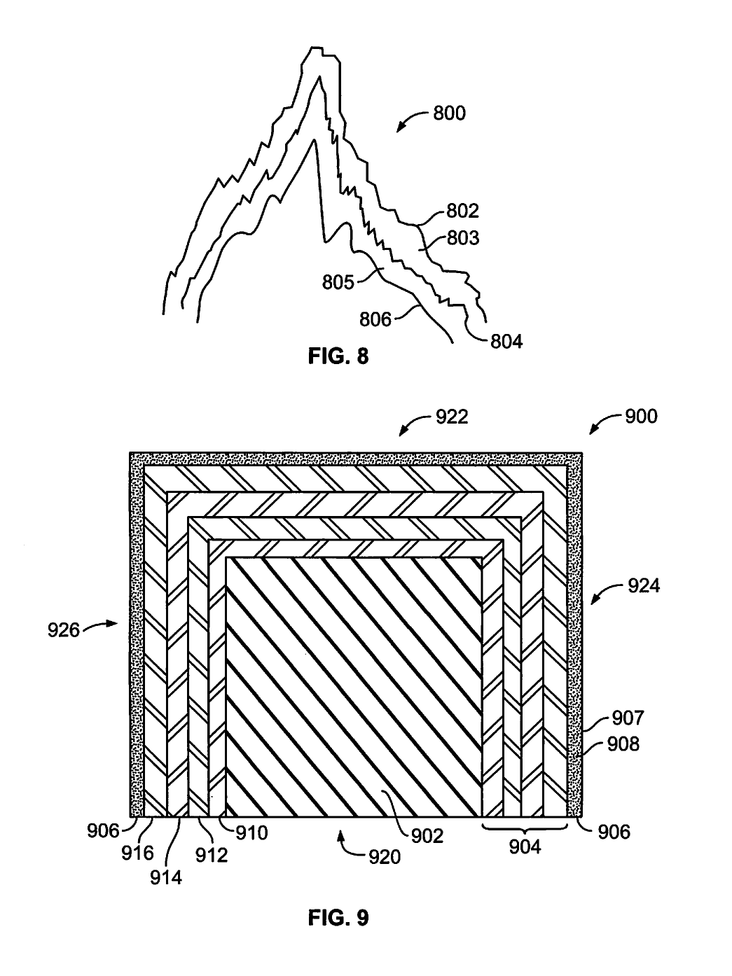

FIG. 8 provides one example of a grain pattern that may be provided by various sublayers. In FIG. 8, a cathedral grain pattern 800 is provided having three grain portions, namely a leading edge 802, an intermediate portion 804, and a trailing edge 806. The various grain portions (and/or areas 803, 805 disposed between grain portions) may have various shadings and depth appearances provided by use of different layers. For example, the leading edge 802 may be provided by a grain pattern included on the sublayer 738a, the intermediate portion 804 may be provided by a grain pattern included on the sublayer 738b, and the trailing edge 806 may be provided by a grain pattern included on the sublayer 738c. In various embodiments, more than one grain pattern may be provided by a given sublayer (e.g. one sublayer may provide both the leading edge 802 and the trailing edge 806). Thus, in the illustrated embodiment, the various grain portions 802, 804, 806 (and/or areas between or near the various grain patterns) may have differing apparent depths, provide a realistic depth to the simulated wood grain.

Alternatively or additionally, sublayers may cooperate to provide a given grain pattern (e.g., one or more sublayers may cooperate to provide the intermediate portion 704). In the embodiment depicted in FIG. 8, the various sublayers are coordinated so that the various grain patterns are positioned in locations corresponding to one another, so that the “V”s formed by the various layers are positioned a desired spacing apart from one another and do not overlap or cancel one another out. In various embodiments, other grain patterns may be simulated (e.g., quartersawn, flame, quilt, or the like).

Returning to FIG. 7, the top coat 720 is disposed above the intermediate portion 730 (e.g., with the intermediate portion 730 interposed between the top coat 720 and the structure 100. The top coat 720 of the illustrated embodiment is relatively thin (e.g., having a relatively low thickness configured to allow the grain simulation to appear close to the surface of the simulated wood product) and is configured for use with exterior applications. In an embodiment, the top coat 720 is relatively thin when a thickness dimension of the top coat 720 is smaller than the thicknesses of all other layers and portions of the structure. The top coat 720 may be configured to provide good abrasion resistance as well as UV resistance (e.g., resistance to fading of the print layers due to exposure to sunlight. The top coat 720 may include a base member configured for UV resistance and an additive configured to provide abrasion resistance. The top coat 720 may be substantially thinner than plastic caps used in some alternate approaches.

The base member of the top coat 720 may be formed using a polymer. For example, in various embodiments, one or more of a urethane, acrylic, fluoropolymer, or other exterior durable polymer system may be employed, for example, to provide light stability. The base member may include one or more functional groups, for example, to crosslink the top coat in order to improve certain properties. As one example, the base member may include a hydroxyl functional group to crosslink with urethane or melamine containing materials. As another example, the base member may include a carboxyl functional group to crosslink with aziradine or oxazolidine containing materials. As still another example, the base member may include a free radical functional group to crosslink, for instance, using UV or E beam radiation. As yet another example, the base member may include a cycloalphatic epoxy functional to crosslink, for instance, using UV or E beam radiation. In various embodiments, the base member may be water based or 100% solids to minimize hazardous organic volatiles.

As indicated above the top coat may also include an additive that is added to (e.g., disposed within) the base member. The additive may include, for example, inorganic particles. The inorganic particles may be configured to improve abrasion resistance and/or provide anti-slip properties. In embodiments, the additive may include particles having a hardness of about 5 MOL or above. In various embodiments, the additive may have a low refractive index to help maximize clarity of the top coat 720. For example, the additive may have a refractive index of about 2.2 or lower. The thickness of the additive (e.g., particle size) may be configured such that the thickness is about 140% or less of the thickness of the base member.

The thickness of the top coat 720 (e.g., the thickness of the base member of the top coat 720) may be determined based on wear requirements of a given application of an end product utilizing the top coat 720. For example, in some embodiments, a thickness of about 0.5 mil or above may be utilized to provide a desired level of wear resistance. In some embodiments, multiple coats may be applied to achieve a desired thickness. Further, in some embodiments, the composition of the multiple coats may vary to achieve a desired property. For example, a first coat or layer of the top coat 720 may have a first composition, and a subsequently applied coat or layer may have a different composition.

The top coat 720, for example, may be sprayed, curtain coated, or the like above the intermediate portion 730 after the intermediate portion 730 has been applied to the substrate. In some embodiments, the base may include a fluoropolymer. The fluoropolymer, for example, may be Polyvinylidene Fluoride (PVDF). The additive may include inorganic particles. The additive may include, for example, Aluminum Oxide (Al₂O₃). The inorganic particles may be sized and distributed in the base member for a particular application. For example, the particles may be sized and provided in a relative proportion relative to the thickness of the top coat 720 such that at least some portions of the particles provide an irregular surface to the top coat 720, providing for a level of grip to one or more exterior surfaces of the simulated wood product as well as abrasion resistance. The additive may include particles having a size, and the thickness of the top coat 720 and the size of the particles may be configured to provide a texture. For example, as indicated above, in some embodiments, the particle size may be about 140% of the thickness of the base member or less. As another example, in some embodiments, the particle size may be selected from a range between about 50% to about 125% of the thickness of the base member. A texture of the top coat 720 may be understood as a tactilely perceptible non-uniform surface. The top coat 720 may have a thickness configured to cooperate with the particle size of the additive to provide for slip resistance (e.g., for people walking on a deck, flooring, walkway, or other surface made with the simulated wood product). In various embodiments, the top coat 720 may be disposed above a top, sides, and/or bottom of the structure 100.

As indicated above, the top coat 720 may be applied by coating. For example, the top coat 720 may be roll coated, curtain or side coated, spray coated, or the like. In some alternative embodiments, a film could be glued or otherwise applied to a graphic image to provide the top coat 720. The film, for example, may be surface modified to provide one or more of a lower gloss, anti-slip characteristics, or abrasion resistance. The film may be composed of an exterior durable polymer (e.g., acrylic, polycarbonate, urethane, or the like). In various embodiments, the film may have a thickness between about 2 mil and about 5 mil. The glue or adhesive may be a single component reactive urethane, or as another example, a two component urethane. The glue or adhesive may be light stable, and may be applied at a thickness configured to provide excellent adhesion between the film and a decorative graphic.

In connection with FIG. 7, a simulated wood product is discussed. In various embodiments, other materials (either natural or man-made) may be simulated, such as stone, stucco, plaster, or the like. A simulated appearance as discussed herein may be understood as an appearance configured to appear different than a natural appearance of a substrate in terms of pattern, texture, or the like. In various embodiments, such a simulated appearance may be achieved via a plurality of partially transparent or translucent layers configured to provide a layered or three-dimensional effect. Patterns of grain or other simulation may be provided having a relatively repetitive appearance in some embodiments, while a random appearance may be employed in other embodiments.

FIG. 9 is a side view of a simulated wood product 900 including a plurality of layers that have been applied or added to a substrate 902. It should be noted that the thicknesses of various layers in FIG. 9 are provided for clarity of illustration and are not intended as a scale representation. For example, one or more layers may be relatively thinner with respect to other layers and/or the substrate. In various embodiments, varying types of layers and/or numbers of layers or sub-layers may be employed. Further, more or less layers or of a given type of layer may be employed.

The simulated wood product 900 includes a substrate 902, intermediate layers 904, and a top coat 906. The intermediate layers 904 are interposed between the substrate 902 and the top coat 906. At least some of the intermediate layers 904 are configured to provide a simulated visual effect, such as to simulate wood grain. The top coat 906 may be configured similarly to the top coat 720 discussed above, and may be configured to provide both UV and abrasion resistance. The substrate 902 may be the external surface of at least part of the structure 100.

The simulated wood product 900 includes a top 922, a bottom 920, a first side 924, and a second side 926. In the illustrated embodiment, the top 922 is configured to be oriented in an outward position relative to the bottom 920. For example, if the simulated wood product 900 were to be used a horizontal application, such as being utilized as a plank of a deck, the simulated wood product 900 is configured so that the top 922 would be facing outward, e.g., as the surface upon which a person traversing the deck would walk. As another example, if the simulated wood product 900 were to be used in a non-horizontal application, such as a garage door, the simulated wood product is configured so that the top 922 would be facing outward (e.g., the bottom 924 positioned more proximate the interior of the garage). In still other embodiments, the simulated wood product 900 may be positioned so that both the top 922 and bottom 920 are configured as facing outward, for example as part of a back rest of a bench that may be formed as part of the deck, and both the top 922 and bottom 920 may be provided with a simulated wood grain.

In the embodiment depicted in FIG. 9, the intermediate layers 904 and the top coat 906 are shown as covering the top 922, the first side 924, and the second side 926. In various embodiments, different arrangements may be employed. As one example, the intermediate layers 904 and top coat 906 may be applied only above or along the top 922. As another example, the top coat 906 may be applied over a larger area than the intermediate layers 904. For example, the intermediate layers 904 may be applied only along the top 922, while the top coat 906 may be applied along the top 922 and one or more of the first side 924 or the second side 926. As still another example, the intermediate layers 904 and top coat 906 may be provided along the entire periphery of the substrate 902 (e.g., along the top 922, first side 924, bottom 920, and second side 926). In such an arrangement, any surface of the simulated wood product may be considered as or employed as a top or outer surface.

The substrate 902 may be a structural member such as a plank, board, beam, sheet, or the like. In some embodiments, the substrate 902 may be formed from one or more plastic or composite materials. Generally speaking, the substrate 902 is configured to provide a desired strength, rigidity, and/or other properties for a given exterior application. The various layers and the top coat 906 are provided over one or more surfaces of the substrate 902 to provide a realistic wood grain appearance as well as desired additional properties such as UV resistance, resistance to chemicals (such as cleaners, fertilizers, or the like), abrasion resistance, slip resistance, or the like.

The intermediate layers 904 include a plurality of layers (which may in some embodiments in turn include sublayers), and may be configured similarly in certain respects to the intermediate portion 730 discussed above in connection with FIG. 7. One or more of the intermediate layers 904 may be applied to the substrate 902 at the same time. In some embodiments, one or more of the intermediate layers 904 may be applied to the substrate at a different time than one or more others of the intermediate layers 904. In the illustrated embodiments, the intermediate layers 904 are configured to provide a realistic simulation of a wood material, for example a wood grain. It should be noted that a given layer depicted as an individual layer in FIG. 9 may be achieved or replaced by multiple layers or sublayers.

The adhesive layer 910 may be similar in certain respects to the adhesive layer 732 discussed in connection with FIG. 7. For example, generally, the adhesive layer is configured to adhere, bond, secure, or the like the various other layers to the substrate 902. The adhesive layer 910 in some embodiments may be a liquid. In some embodiments, the adhesive layer 910 may be heat activated and thermally applied, for example as a foil or as an exterior layer of a foil.

The ground layer 912 may be similar in certain respects to the ground coat layer 734 discussed in connection with FIG. 7. Generally, the ground coat 912 of the illustrated embodiment is configured to provide a base for additional layers positioned above (e.g., farther from an exterior surface of the substrate 902). The ground coat 912 may be the same color or a different color than the print undertone layer 914.

The print undertone layer 914 may be configured similarly in certain respects to the print undertone layer 736 discussed in connection with FIG. 7. For example, the print undertone layer 914 may be translucent or have variable translucence to allow a portion of the ground coat layer 912 to appear through the print undertone layer 914, while in other embodiments, the print undertone layer 914 may be substantially opaque. The print undertone layer 736 may be selected or configured to simulate a base color of a given type or variety of wood. The print undertone layer may be substantially uniform in color or shade distribution, or may have variance or gradation of shade.

The print layer 916 may be configured similarly to the print layer 738 discussed above in connection with FIG. 7. For example, the print layer 916 may include a plurality of sublayers (not shown in FIG. 9) configured to provide a realistic layered depth effect. The print layer 916 may be formed of one or more pre-printed sheets or foils that are configured to have corresponding patterns or sub-patterns that cooperate with each other to form a coordinated pattern, such as a wood grain pattern, that includes contributions from a plurality of layers. Thus, various portions of a grain pattern may be lighter or darker and/or have the appearance of varying depth relative to other portions of a grain pattern.

The top coat 906 may be configured similarly in certain respect to the top coat 720 discussed above in connection with FIG. 7. For example, the top coat 906 depicted in FIG. 9 is configured to be relatively thin (e.g., having a relatively low thickness configured to allow the grain simulation to appear close to the surface of the simulated wood product 900), and is configured for use with exterior applications. In the illustrated embodiment, the top coat 906 includes a base member 907 configured for UV resistance and an additive 908 configured to provide abrasion resistance. In some embodiments, the base member 907 may include a fluoropolymer, such as PVDF. The additive 208 may include inorganic particles, for example, including Aluminum Oxide (Al₂O₃).

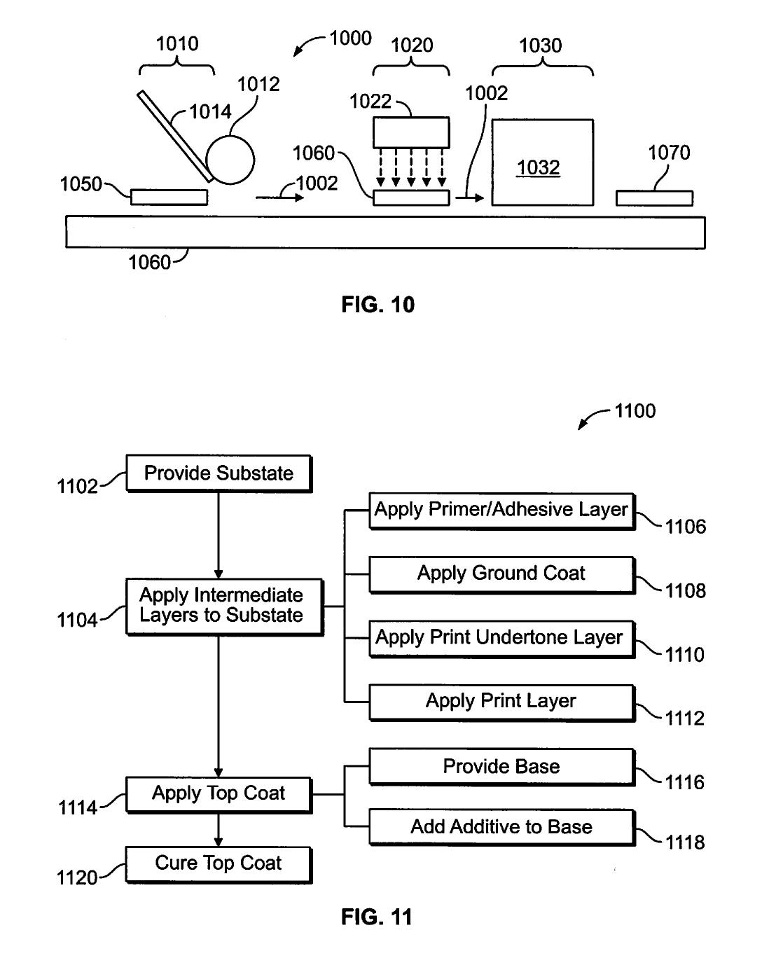

FIG. 10 is a schematic view of a system 1000 configured to provide a simulated product, such as the simulated wood products described above. The various zones or stations of the system 1000 are joined by a transport mechanism such as a substrate transport 1040. The substrate transport 1040 may be configured, for example, as a conveyor belt or the like. The various zones may be part of one generally continuous line disposed at a single generally contiguous location or facility, or alternatively may be configured as two or more separate lines located remotely at one or more facilities.

The system 1000 includes a first zone 1010, a second zone 1020, and a third zone 1030 linked by the substrate transport 1040. In the illustrated embodiment, the first zone 1010 is configured as a decorating zone or station configured to add an adhesive as well as a visual simulation effect (e.g., wood grain) portion that may include a plurality of layers (e.g., base coat, undertone, print layer). The second zone 1020 may be configured as a top coat application zone or station, and the third zone 1030 may be configured as a drying and/or curing zone or station configured to dry or cure the top coat that has been applied to the substrate. In various embodiments, each zone depicted in FIG. 10 may be broken into a plurality of zones or sub-zones (e.g., multiple zones for adding an adhesive layer separately from other layers, adding decorative layers sequentially, or the like) and/or additional zones, stations, or processes may be employed.

In the illustrated embodiment, the first zone 1010 is configured to receive a substrate 1050 (e.g., a substrate such as the substrate described elsewhere herein) conveyed by the substrate transport 1040, and to apply an exterior foil 1014 that is configured to provide a visual simulation (e.g., a wood grain simulation) to the substrate 1050. In the illustrated embodiment, the first zone 1010 is configured as an intermediate coating station configured to apply plural intermediate layers to the substrate 1050. The exterior foil 1014 may include a plurality of intermediate layers as discussed elsewhere herein and may be laminated or transferred to the substrate 1050 using heat activated adhesive in some embodiments, and may be wet applied in other embodiments. In the illustrated embodiment, the first zone 1010 includes a pressure roller 1012 configured to apply the exterior foil 1014 to one or more surfaces of the substrate 1050 to provide a decorated substrate 1060. The roller pressure may be applied at various angles to cover all surfaces of the substrate 1060 that require decoration. In some embodiments multiple rollers may be employed (e.g., a first roller to apply a foil to the top of a substrate and a second roller to apply a foil to the side of a substrate). A single foil may be applied to more than one surface of the substrate, or each surface of the substrate to receive a decoration may receive a foil sized and configured for that particular surface. In alternate embodiments, an adhesive and/or primer layer may be applied initially before other layers, and/or one or more layers may be applied sequentially using a plurality of zones or sub-zones. In the illustrated embodiment, after the exterior foil 1014 is applied to the substrate 1050 to provide a decorated substrate 1060, the decorated substrate 1060 is advanced in direction 1002 to the second zone 1020.

At the second zone 1020, the decorated substrate 1060 receives a top coat (e.g., top coat 720, top coat 906). In the illustrated embodiment, the second zone 1020 includes a spraying station 1022 configured to spray the top coat onto the decorated substrate 1060. In alternate embodiments, the second zone 1020 may be configured to coat the decorated substrate 1060 using a curtain coating process or other coating process. In various embodiments, the top coat may be applied to a single surface of the decorated substrate 1060 (e.g., the top) or multiple surfaces of the decorated substrate 1060 (e.g., top and sides; top, bottom, and sides). The second zone 1020 is configured to apply the top coat as a relatively thin coating or layer that allows for the grain pattern provided by the intermediate layers to be close to the surface as seen by an observer. The thickness of the top coat and the size of particles added to the top in various embodiments are matched to provide an abrasion resistance required or desired for a given application. After the top coat is applied, the decorated substrate 1060 with the top coat applied is advanced in direction 1002 to the third zone 1030.

The third zone 1030 of the depicted embodiment is configured as a drying or curing zone for drying or curing the top coat. The third zone may include a drying or curing station 1032 including one or more of a heater, blower, or the like to dry or cure the top coat. The third zone 1030 of the illustrated embodiment may be configured to dry or cure the top coat such that an additive of the top coat is locked into position and/or creates a bond to the decorated surfaces of the decorated substrate 1060. The additive may be positioned such that a portion of at least some of the particles of the additive are located above the coating surface of the top coat base to allow for texture. Such positioning may create a slip resistant surface, enhance abrasion and long term wear, and/or may enhance short term wear, for example due to scratching or the like. After the drying or curing, the simulated product 1070, now having a cured or dried top coat above a decorative intermediate portion, may be advanced along direction 1002 out of the drying or curing station 1022 and cooled before further transport. Once cooled, the simulated product 1070 is ready for transport to a sales location, distribution location, and/or installation location and is ready for installation and use.

FIG. 11 is a flowchart of one embodiment of a method 1100 for providing a simulated product, such as a simulated wood product. The method 1100 may be used in conjunction, for example, with one or more embodiments of the system 1000 shown in FIG. 10 and described herein, and/or used to provide a simulated product such as simulated wood product shown in FIGS. 7 and 9, and as described herein. In various embodiments, certain steps may be omitted or added, certain steps may be combined, certain steps may be performed simultaneously, certain steps may be performed concurrently, certain steps may be split into multiple steps, certain steps may be performed in a different order, or certain steps or series of steps may be re-performed in an iterative fashion.

At 1102, a substrate (e.g., substrate 710 or substrate 902) is provided. The substrate may be configured for use in an exterior application (e.g., decking, roofing, garage door, or the like). A simulated appearance will be applied to the substrate as part of the method 1100. In the depicted embodiment, the substrate will be provided with a simulated wood grain appearance.

At 1104, intermediate layers are applied to the substrate. One or more of the intermediate layers may be applied sequentially and/or at once. The intermediate layers may be configured to provide a simulated wood grain appearance to the substrate, and may be applied to one or more surfaces of the substrate. The intermediate layers may include sub-layers. In the depicted embodiment, the intermediate layers include a primer/adhesive layer, a ground coat layer, a print under tone layer, and a print layer. In some embodiments, the various layers may be combined and provided as a foil including a heat activated adhesive/primer layer that is oriented toward a surface of the substrate, with the foil being thermally applied to the substrate. In the illustrated embodiment, the application of intermediate layers may include a plurality of sub-steps discussed below.

At 1106, a primer/adhesive layer (e.g., layers 732, 910) is applied to one or more surfaces of the substrate. In some embodiments, the primer/adhesive layer may be applied separately to the substrate from the other layers, while in other embodiments the primer/adhesive layer may be provided as an adhesive layer of a foil including one or more additional intermediate layers. In some embodiments, the primer/adhesive layer is a liquid that is wet applied to the substrate, while in other embodiments the primer/adhesive layer may be thermally applied or laminated to the substrate.

At 1108, a ground coat (e.g., the ground coat layers 734, 912) is applied. In some embodiments, the ground coat may be applied to the adhesive/primer layer as part of forming a foil to be applied to the substrate, while in other embodiments, the ground coat may be applied to an adhesive/primer layer that has already been applied to the substrate.

At 1110, a print undertone layer (e.g., the layers 736, 914) is applied. The print under tone layer may include two or more sublayers in some embodiments. In various embodiments, the print undertone layer (or one or more sublayers thereof) may be applied to the ground coat layer as part of forming a foil to be applied to the substrate, while in other embodiments, the print undertone layer (or one or more sublayers thereof) may be applied above a ground coat layer that has already been applied to the substrate (e.g., to an adhesive/primer layer previously applied to the substrate).

At 1112, a print layer (e.g., print layers 738, 916) is applied. The print layer may include two or more sublayers in some embodiments. In various embodiments, the print layer (or one or more sublayers thereof) may be applied to the print under tone layer as part of forming a foil to be applied to the substrate, while in other embodiments, the print layer (or one or more sublayers thereof) may be applied above a print undertone layer that has already been applied to the substrate (e.g., to a ground coat previously applied to the substrate).

At 1114, a top coat (e.g., top coat layers 740, 906) is applied above the print layer. The top coat may be applied by a spraying or coating process above one or more surfaces of a substrate (e.g., above an intermediate layer that has previously been applied to the substrate). The top coat may be configured for exterior use, for example to provide UV resistance to prevent or reduce fading of a print layer due to sunlight. In the illustrated embodiment, the top coat is formed before application by 1116 and 118.

At 1116, a base member (e.g., base layer 907) is provided. The base member, for example, may be UV resistant. The base member, however, may not provide a desired or required slip and/or abrasion resistance for exterior applications such as decking. At 1118, an additive (e.g., additive 908) is added to the base member to, for example, provide improved abrasion resistance. The additive, for example, may include inorganic particles. In the embodiment depicted in FIG. 11, the thickness of the top coat and the size and distribution of the additive are selected to provide a desired slip resistance and/or abrasion or wear resistance.

At 1120, the top coat is cured or dried. The top coat may be cured or dried to lock the additive in position within the top coat and create a bond to decorative surface. Particles of the additive may be positioned to provide improved or enhance slip resistance, long term wear resistance, and/or short term wear resistance.

Thus, in various embodiments, a product having a simulated appearance (e.g., wood grain) is provided. The simulated appearance may be provided by a plurality of layers providing a depth to the visual simulation. Further, the simulated appearance product may be provided with a top coat configured to be thin enough to allow the simulated appearance to be close to the outermost surface of the simulated appearance product while still providing desired characteristics (e.g., UV resistance, chemical resistance, wear resistance, slip resistance, or the like) for exterior applications (e.g., decking). For example, embodiments may provide UV durability of 10 or more years of fade and/or chalk resistance. Embodiments may provide long term wear resistance to allow for foot traffic or other performance needs. Embodiments may provide short term wear resistance to allow for increased resistance to scratching or the like. Embodiments may provide chemical and stain resistance from general household chemicals and cleaners. Embodiments may provide for improved ease of installation and storage, for example, as the relatively thin top coat that is permanently bonded to the decorative layers may eliminate or reduce separation of a top layer due to part flexure, expansion or contraction (e.g., due to temperature fluctuations experienced in exterior applications), cutting during or prior to installation, application of screws or other fasteners, or the like.

In one embodiment, a surface appearance simulation system includes a carrier web, an overcoat layer disposed on the carrier web, a pigment layer having one or more inks forming a design on the overcoat layer, and a ground coat layer. The carrier web supports the overcoat layer, the pigment layer and the ground coat layer during application of the ground coat layer with a surface of a target object prior to removing the carrier web from the overcoat layer with the carrier web directly abutting the overcoat layer without one or more slip additive materials between the carrier web and the overcoat layer prior to removing the carrier web.

In one example, one or more inks of the pigment layer are printed directly onto the overcoat layer.

In one example, the one or more inks of the pigment layer directly abut the overcoat layer.

In one example, the carrier web directly abuts the overcoat layer without one or more waxes or silicone materials as the one or more slip additive materials between the carrier web and the overcoat layer.

In one example, the overcoat layer is formed from one or more monomers of acrylate, methacrylate, vinyl chloride, or vinyl acetate.

In one example, the overcoat layer includes at least one functional group that includes one or more of hydroxyl, carboxyl, amine, or glycidyl.

In one example, the overcoat layer has a molecular weight of at least 30,000 and no more than 120,000.

In one example, the overcoat layer has a glass transition temperature of at least 35 degrees centigrade and no more than 140 degrees centigrade.

In one example, the overcoat layer has an acid number of at least 2.5 and no more than 200.

In one example, the one or more inks in the pigment layer include one or more organic pigments, inorganic oxides, or complex inorganic colored pigments, pearl, metallic effects pigment.

In one embodiment, a system includes a post-applied protective layer, an overcoat layer connected with the post-applied protective layer, a pigment layer having one or more inks forming a design on the overcoat layer, and a ground coat layer configured to be adhered with a surface of a target object to change an appearance of the target object using the design of the pigment layer. The overcoat layer protects the overcoat layer and the pigment layer from mechanical damage and wherein the overcoat layer and the overcoat layer are chemically bonded with each other.

In one example, the one or more inks directly abut the overcoat layer.

In one example, the post-applied protective layer is cured from a liquid application of one or more polymer materials that form the overcoat layer.

In one example, the post-applied protective layer is a laminated film on the overcoat layer.

In one example, the overcoat layer is formed from polymer or copolymer of one or more monomers of acrylate, methacrylate, vinyl chloride, or vinyl acetate and cellulose.

In one embodiment, a method includes providing an overcoat layer onto a carrier web and depositing one or more inks to form a pigment layer on the overcoat layer. The one or more inks may form a design. The method also can include providing a ground coat layer on the pigment layer, applying an adhesive to one or more of a surface of a target object or the ground coat layer, adhering the ground coat layer with the surface of the target object using the adhesive, and removing the carrier web from the overcoat layer to cause the design in the pigment layer to appear on the surface of the target object. The carrier web is removed from the overcoat layer without one or more slip additive materials between the carrier web and the overcoat layer prior to removing the carrier web.

In one example, depositing the one or more inks includes printing the one or more inks directly onto the overcoat layer.

In one example, the method also includes applying a liquid post-applied protective layer onto the overcoat layer after removing the carrier web, and curing the liquid post-applied protective layer to form an additional overcoat layer on the overcoat layer.

In one example, the method also includes laminating a protective laminated film onto the overcoat layer after removing the carrier web.

In one example, laminating the post-applied protective laminated film includes extruding the protective laminated film onto the overcoat layer.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the inventive subject matter without departing from its scope. While the dimensions and types of materials described herein are intended to define the parameters of the inventive subject matter, they are by no means limiting and are exemplary embodiments. Many other embodiments will be apparent to one of ordinary skill in the art upon reviewing the above description. The scope of the inventive subject matter should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112(f), unless and until such claim limitations expressly use the phrase “means for” followed by a statement of function void of further structure. For example, the recitation of a “mechanism for,” “module for,” “device for,” “unit for,” “component for,” “element for,” “member for,” “apparatus for,” “machine for,” or “system for” is not to be interpreted as invoking 35 U.S.C. §112(f), and any claim that recites one or more of these terms is not to be interpreted as a means-plus-function claim.

This written description uses examples to disclose several embodiments of the inventive subject matter, and also to enable one of ordinary skill in the art to practice the embodiments of inventive subject matter, including making and using any devices or systems and performing any incorporated methods. The patentable scope of the inventive subject matter is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

The foregoing description of certain embodiments of the present inventive subject matter will be better understood when read in conjunction with the appended drawings. The various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” or “an embodiment” of the presently described inventive subject matter are not intended to be interpreted as excluding the existence of additional embodiments that also incorporate the recited features. Moreover, unless explicitly stated to the contrary, embodiments “comprising,” “comprises,” “including,” “includes,” “having,” or “has” an element or a plurality of elements having a particular property may include additional such elements not having that property.

What is claimed is:

1. A surface appearance simulation system comprising:
a carrier web;
an overcoat layer disposed on the carrier web; and
a pigment layer having one or more inks forming a design on the overcoat layer, wherein the carrier web supports the overcoat layer and the pigment layer during application of the overcoat layer and the pigment layer with a surface of a target object prior to removing the carrier web from the overcoat layer with the carrier web directly abutting the overcoat layer without one or more slip additive materials between the carrier web and the overcoat layer prior to removing the carrier web.

2. The system of claim 1, further comprising a ground coat layer with the pigment layer between the ground coat layer and the overcoat layer, wherein the carrier web supports the overcoat layer, the pigment layer, and the ground coat layer during application of the ground coat layer, the overcoat layer, and the pigment layer with the surface of the target object prior to removing the carrier web from the overcoat layer.

3. The system of claim 1, wherein the one or more inks of the pigment layer are printed directly onto the overcoat layer.

4. The system of claim 1, wherein the one or more inks of the pigment layer directly abut the overcoat layer.

5. The system of claim 1, wherein the carrier web directly abuts the overcoat layer without one or more waxes or silicone materials as the one or more slip additive materials between the carrier web and the overcoat layer.

6. The system of claim 1, wherein the overcoat layer is formed from one or more monomers of acrylate, methacrylate, vinyl chloride, or vinyl acetate.

7. The system of claim 1, wherein the overcoat layer includes at least one functional group that includes one or more of hydroxyl, carboxyl, amine, or glycidyl.

8. The system of claim 1, wherein the overcoat layer has a molecular weight of at least 30,000 and no more than 120,000.

9. The system of claim 1, wherein the overcoat layer has a glass transition temperature of at least 35 degrees centigrade and no more than 140 degrees centigrade.

10. The system of claim 1, wherein the overcoat layer has an acid number of at least 2.5 and no more than 200.

11. The system of claim 1, wherein the one or more inks in the pigment layer include one or more organic pigments, inorganic oxides, or complex inorganic colored pigments, pearl, metallic effects pigment.

12. A system comprising:
a post-applied protective layer;
an overcoat layer connected with the post-applied protective layer;
a pigment layer having one or more inks forming a design on the overcoat layer; and
a ground coat layer configured to be adhered with a surface of a target object to change an appearance of the target object using the design of the pigment layer, wherein the overcoat layer protects the overcoat layer and the pigment layer from mechanical damage and wherein the overcoat layer and the overcoat layer are chemically bonded with each other.

13. The system of claim 12, wherein the one or more inks directly abut the overcoat layer.

14. The system of claim 12, wherein the post-applied protective layer is cured from a liquid application of one or more polymer materials that form the overcoat layer.

15. The system of claim 12, wherein the post-applied protective layer is a laminated film on the overcoat layer.

16. The system of claim 12, wherein the overcoat layer is formed from polymer or copolymer of one or more monomers of acrylate, methacrylate, vinyl chloride, or vinyl acetate and cellulose.

17. A method comprising:
providing an overcoat layer onto a carrier web;
depositing one or more inks to form a pigment layer on the overcoat layer, the one or more inks forming a design;
providing a ground coat layer on the pigment layer;
applying an adhesive to one or more of a surface of a target object or the ground coat layer;
adhering the ground coat layer with the surface of the target object using the adhesive; and
removing the carrier web from the overcoat layer to cause the design in the pigment layer to appear on the surface of the target object, wherein the carrier web is removed from the overcoat layer without one or more slip additive materials between the carrier web and the overcoat layer prior to removing the carrier web.

18. The method of claim 17, wherein depositing the one or more inks includes printing the one or more inks directly onto the overcoat layer.

19. The method of claim 17, further comprising:
applying a liquid post-applied protective layer onto the overcoat layer after removing the carrier web; and
curing the liquid post-applied protective layer to form an additional overcoat layer on the overcoat layer.

20. The method of claim 19, further comprising laminating a protective laminated film onto the overcoat layer after removing the carrier web.

21. The method of claim 20, wherein laminating the post-applied protective laminated film includes extruding the protective laminated film onto the overcoat layer.

22. A system comprising:
a fluoropolymer protective film with a pigment layer having one or more inks forming a design on such protective film.

23. The system of claim 22, further comprising a ground coat layer configured to be adhered with a surface of a target object to change an appearance of the target object using the design of the pigment layer, wherein the protective film protects the pigment layer from mechanical and environmental damage.
